(19) United States
(12) Patent Application Publication
(10) Pub. No.: US 2023/0193943 A1
(43) Pub. Date: Jun. 22, 2023

(54) NUT ASSEMBLY

(71) Applicant: Zhongshan Fengheng Hardware Technology Co., Ltd., Zhongshan (CN)

(72) Inventor: Yulan QIN, Zhongshan (CN)

(21) Appl. No.: 17/700,660

(22) Filed: Mar. 22, 2022

(30) Foreign Application Priority Data
Dec. 22, 2021 (CN) 202111579074.1

(51) Int. Cl. F16B 39/38

(52) U.S. Cl. CPC F16B 39/38

(57) ABSTRACT

A nut assembly is disclosed, including: a first nut provided with an accommodating cavity; a second nut provided with a collar portion at one end, where the collar portion is movably inserted in the accommodating cavity, and at least one notch is formed on a side wall of the collar portion; an squeezing structure, where when the first nut and the second nut move close to each other, the extrusion structure is capable of squeezing the collar portion to shrink and close; and an anti-dropping structure, where the anti-dropping structure is capable of restricting the collar portion from dropping out of the accommodating cavity.

### CROSS-REFERENCE TO RELATED APPLICATION

This application is based on and claims the benefit of priority from Chinese Patent Application No. 2021115790741, filed on 22 Dec. 2021, the entirety of which is incorporated by reference herein.

### TECHNICAL FIELD

The disclosure relates to the field of nuts, and more particularly, to a nut assembly.

### BACKGROUND

It is well-known that a nut is mainly used for locking a workpiece cooperatively with a bolt. The nut is threadedly connected onto the bolt. When the nut is vibrated, the nut may rotate on the bolt and drop out by itself, so that the workpiece cannot be locked, and there is a potential safety hazard.

In order to prevent the nut from accidentally loosening and dropping out, the self-locking bolt in the existing technology uses a double-nut locking structure or a spring washer. However, when these nuts are applied to an environment with severe vibration, the nuts may still loosen from the bolts, so that there is a potential safety hazard.

### SUMMARY

The disclosure aims to solve at least one of the technical problems in the existing technology. Therefore, the disclosure provides a nut assembly with a good locking effect.

In order to solve the above technical problem, the following technical solutions are used in the disclosure.

A nut assembly in some embodiments of the disclosure includes: a first nut, wherein one end of the first nut is provided with an open accommodating cavity; a second nut, wherein the second nut and the first nut are capable of moving close to or away from each other, one end of the second nut is provided with a collar portion, the collar portion is movably inserted into the accommodating cavity, and at least one notch is formed on a side wall of the collar portion; a squeezing structure arranged between the collar portion and the accommodating cavity, wherein when the first nut and the second nut move close to each other, the squeezing structure is capable of squeezing the collar portion to shrink and close; and an anti-dropping structure arranged between the first nut and the second nut, wherein the anti-dropping structure is capable of restricting the collar portion from dropping out of the accommodating cavity.

In some embodiments of the disclosure, the collar portion is a conical boss, the squeezing structure includes a first guide inclined plane formed on a peripheral side wall of the conical boss, and when the first nut and the second nut move close to each other, an end portion of the accommodating cavity or an inner wall of the accommodating cavity is contacted with the first guide inclined plane and squeezes the collar portion to shrink and close.

In some embodiments of the disclosure, the squeezing structure includes a second guide inclined plane formed on an inner wall of the accommodating cavity, and when the first nut and the second nut move close to each other, the second guide inclined plane is contacted with the first guide inclined plane and squeezes the collar portion to shrink and close.

In some embodiments of the disclosure, the at least one notch includes a plurality of notches, and the plurality of the notches are arranged at intervals in a circumferential direction of the collar portion.

In some embodiments of the disclosure, the plurality of notches are uniformly arranged in the circumferential direction of the collar portion.

In some embodiments of the disclosure, one of the at least one notch is an open groove penetrating through the collar portion and the second nut.

In some embodiments of the disclosure, the anti-dropping structure includes an annular clamping groove and a clamping block which are matched and clamped with each other, one of the annular clamping groove and the clamping block is arranged on an inside wall of the accommodating cavity, and the other one is arranged on the collar portion, and along an axial direction of the first nut or the second nut, a depth of the annular clamping groove is greater than a thickness of the clamping block.

In some embodiments of the disclosure, the annular clamping groove is arranged on the inside wall of the accommodating cavity; and the clamping block is arranged at one end of the collar portion away from the second nut.

In some embodiments of the disclosure, the clamping block is a convex block arranged on a peripheral side wall of an end portion of the collar portion.

In some embodiments of the disclosure, the clamping block is an annular convex strip arranged on the peripheral side wall of the end portion of the collar portion.

The nut assembly in some embodiments of the disclosure has the beneficial effects as follows. The squeezing structure is arranged between the first nut and the second nut, when the first nut and the second nut move close to each other, the squeezing structure is capable of squeezing the collar portion to shrink and close to clamp the bolt, thus realizing self-locking. Meanwhile, the anti-dropping structure is arranged between the first nut and the second nut, which is capable of restricting the collar portion from dropping out of the accommodating cavity, thus preventing the first nut from being separated from the second nut, and facilitating use of the nut assembly.

### BRIEF DESCRIPTION OF THE DRAWINGS

The disclosure is further described in detail hereinafter with reference to the drawings and the embodiments.

FIG. 1 is a schematic structural diagram of a nut assembly in some embodiments of the disclosure;

FIG. 2 is a cross-sectional view of an internal structure of the nut assembly shown in FIG. 1 in an unlocked state;

FIG. 3 is a cross-sectional view of an internal structure of the nut assembly shown in FIG. 1 in a locked state;

FIG. 4 is a cross-sectional view of an internal structure of a first nut in the nut assembly shown in FIG. 1; and

FIG. 5 is a part drawing of a second nut in the nut assembly shown in FIG. 1.

### DETAILED DESCRIPTION

This part will describe the embodiments of the disclosure in detail, and the preferred embodiments of the disclosure are shown in the drawings. The drawings are used to supplement the description of the text in the specification with the graphs, so that people can intuitively and vividly understand each technical feature and the overall technical solution of the disclosure, but the drawings cannot be understood as limiting the scope of protection of the disclosure.

In the description of the disclosure, it should be understood that the positional descriptions referred to, for example, the directional or positional relationships indicated by up, down, front, rear, left, right, etc., are based on the directional or positional relationships shown in the drawings, and are only for convenience and simplification of description of the disclosure, but not for indicating or implying that the referred device or element must have a specific direction, be constructed and operated in a specific direction, and thus should not be construed as limiting the disclosure.

In the description of the disclosure, “several” means one or more, “a plurality of” means more than two, “greater than a number”, “less than a number”, “exceed a number” and the like indicate that the number is excluded, and “above a number”, “below a number”, “within a number”, and the like indicate that the number is included. “First” and “second” if described are only used to distinguish between technical features but cannot be used to indicate or imply relative importance or implicitly specify a quantity of indicated technical features or implicitly specify a sequential relationship of indicated technical features.

In the description of the disclosure, unless otherwise expressly defined, the terms such as “disposed”, “mounted”, and “connected” should be understood in a broad sense. For persons of ordinary skill in the art, specific meanings of the terms in the disclosure may be appropriately determined with reference to the specific content in the technical solution.

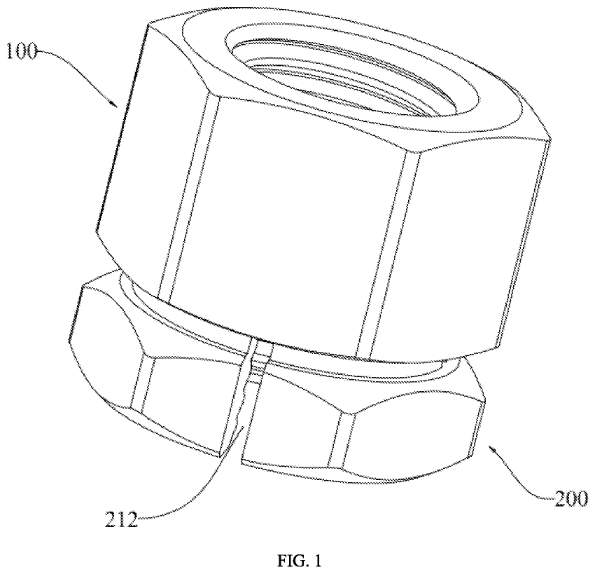

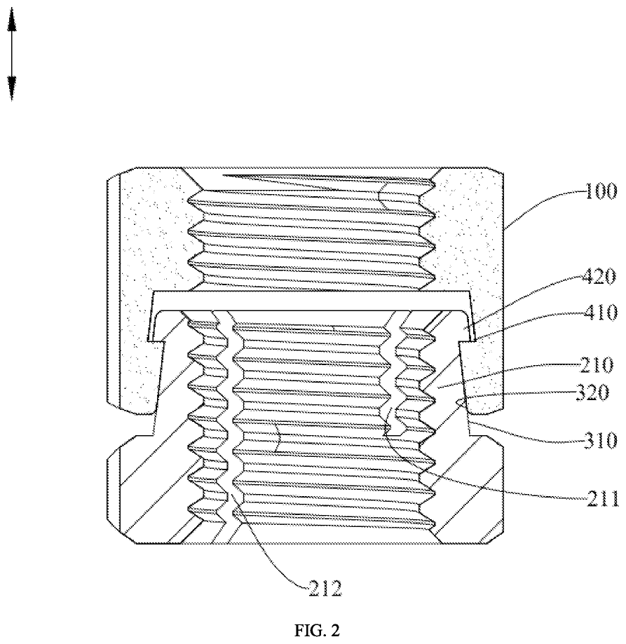

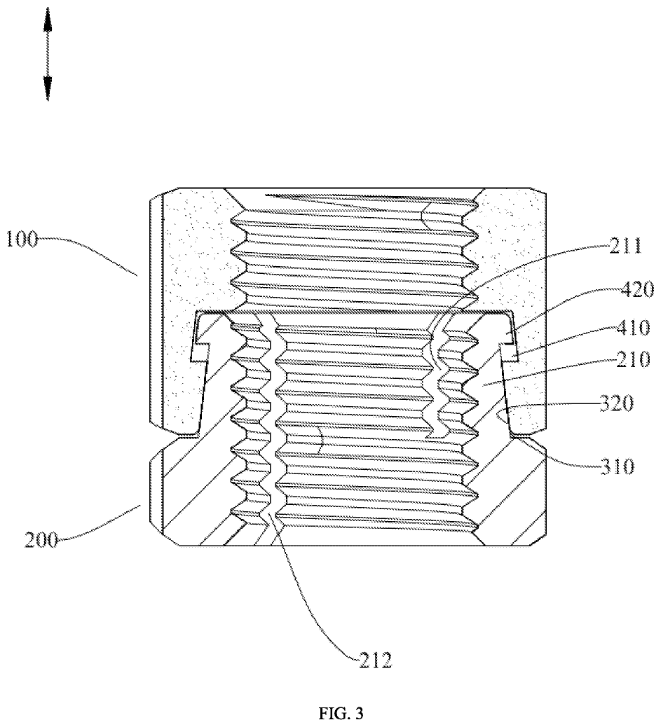

With reference to FIG. 1 to FIG. 5 (directions of arrows in FIG. 2 and FIG. 3 indicate directions in which a first nut 100 moves with respect to a second nut 200), a nut assembly in some embodiments of the disclosure includes a first nut 100 and a second nut 200. One end of the first nut 100 is provided with an open accommodating cavity 110. The second nut 200 and the first nut 100 are independent of each other and are capable of moving close to or away from each other. In the embodiment, the second nut 200 is coaxially arranged with the first nut 100, and one end of the second nut 200 is provided with a collar portion 210 extending outwardly along an axial direction of the second nut 200. As shown in FIG. 5, four notches 211 are formed on a side wall of the collar portion 210. It can be understood that, one, two, three or more notches 211 may also be formed on the side wall of the collar portion 210, which may be determined according to actual needs, but not limited to four. The collar portion 210 is movably inserted into the accommodating cavity 110. When the second nut 200 and the first nut 100 move close to each other, the collar portion 210 is capable of moving towards an inside of the accommodating cavity 110 along an axial direction of the first nut 100. When the second nut 200 and the first nut 100 move away from each other, the collar portion 210 is capable of moving towards an outside of the accommodating cavity 110 along the axial direction of the first nut 100. A squeezing structure is arranged between the collar portion 210 and the accommodating cavity 110, and when the first nut 100 and the second nut 200 move close to each other, the squeezing structure is capable of squeezing the collar portion 210 to shrink and close. An anti-dropping structure is arranged between the first nut 100 and the second nut 200, and the anti-dropping structure is capable of restricting the collar portion 210 from dropping out of the accommodating cavity 110.

According to the nut assembly in the embodiment, by arranging the squeezing structure between the first nut 100 and the second nut 200, the first nut 100 and the second nut 200 are threadedly connected onto one bolt (not shown in the drawings). When a user screws the first nut 100 or the second nut 200 to rotate, and the first nut 100 and the second nut 200 move close to each other along the bolt, the squeezing structure is capable of squeezing the collar portion 210 to shrink and close to clamp the bolt, so that the nut assembly is locked on the bolt and not easy to loosen, thus realizing self-locking. When the user screws the first nut 100 to rotate reversely, and then the first nut 100 and the second nut 200 move away from each other, the squeezing structure no longer squeezes the collar portion 210 at the moment, and the collar portion 210 is opened outwardly without clamping the bolt, thus unlocking the bolt assembly. The second nut 200 is capable of rotating relative to the bolt at the moment, and the user may synchronously rotate the first nut 100 and the second nut 200, so that the nut assembly is removed from the bolt, thus being simple and convenient in use. Meanwhile, in the embodiment, the anti-dropping structure is arranged between the first nut 100 and the second nut 200, which is capable of restricting the collar portion 210 from dropping out of the accommodating cavity 110 and effectively preventing the first nut 100 from being separated from the second nut 200. Therefore, when using the nut assembly, the user does not need to pick up the first nut 100 or the second nut 200 one by one, which is convenient for use of the nut assembly, and avoids the first nut 100 or the second nut 200 from losing at the same time, thus affecting the use of the nut assembly.

With reference to FIG. 2 to FIG. 5, in order to facilitate the squeezing structure to squeeze the collar portion 210, in some embodiments of the disclosure, the collar portion 210 is a conical boss. In the embodiment, a cross-sectional area of the conical boss is gradually reduced along a direction from a free end of the conical boss to a fixed end of the conical boss. The fixed end of the conical boss refers to an end of the conical boss connected with the second nut 200, and the free end of the conical boss refers to an end of the conical boss away from the second nut 200. The squeezing structure includes a first guide inclined plane 310 formed on a peripheral side wall of the conical boss, and when the first nut 100 and the second nut 200 move close to each other, an end portion of the accommodating cavity 110 or an inner wall of the accommodating cavity 110 is contacted with the first guide inclined plane 310 and squeezes the collar portion 210 to shrink and close. By using the above structure, the closer the first nut 100 and the second nut 200 move to each other, the larger a squeezing force exerted by the end portion of the accommodating cavity 110 or the inner wall of the accommodating cavity 110 on the first guide inclined plane 310 is, so that the collar portion 210 is capable of better clamping the bolt, thus locking the nut assembly on the bolt better, and achieving a better self-locking performance.

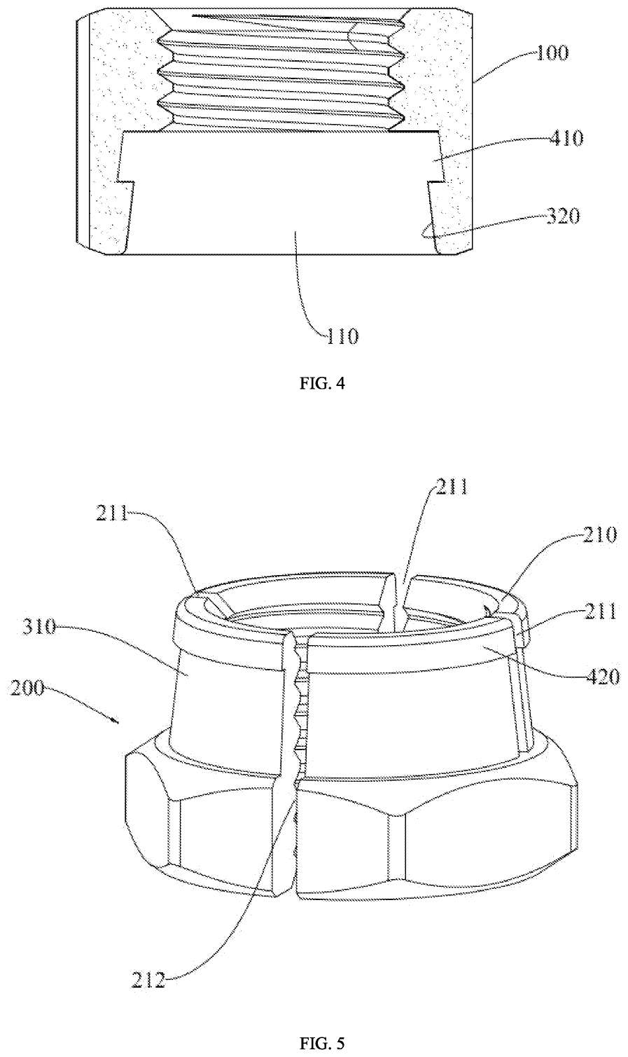

With reference to FIG. 3, FIG. 4 and FIG. 5, the squeezing structure includes a second guide inclined plane 320 formed on an inner wall of the accommodating cavity 110, and when the first nut 100 and the second nut 200 move close to each other, the second guide inclined plane 320 is contacted with the first guide inclined plane 310 and squeezes the collar portion 210 to shrink and close. By using the above structure, the second guide inclined plane 320 is matched with the first guide inclined plane 310 for squeezing, so that the first guide inclined plane 310 is squeezed integrally, and the first guide inclined plane 310 is squeezed more uniformly, thus making the collar portion 210 close better to clamp the bolt, and achieving a better locking effect.

With reference to FIG. 2, FIG. 3 and FIG. 4, in order to make the collar portion 210 shrink and close better, the four notches 211 are arranged at intervals in a circumferential direction of the collar portion 210. Further, the four notches 211 are uniformly arranged in the circumferential direction of the collar portion 210. It can be understood that, in some embodiments of the disclosure, a plurality of notches 211 may also be provided, and the plurality of notches 211 are uniformly arranged in the circumferential direction of the collar portion 210. By using the above structure, the collar portion 210 may shrink and close along a circumferential direction of the bolt to clamp the bolt, thus achieving a better clamping effect.

In order to make the self-locking performance of the nut assembly better, in some embodiments of the disclosure, one of the notches 211 is an open groove 212 penetrating through the collar portion 210 and the second nut 200. As shown in FIG. 5, specifically, along an axial direction of the second nut 200, the open groove 212 penetrates through the collar portion 210 and the second nut 200 integrally. Therefore, when the squeezing structure squeezes the collar portion 210 to shrink and close, not only the collar portion 210 shrinks and closes to clamp the bolt, but also the second nut 200 shrinks and closes to clamp the bolt. The collar portion 210 and the second nut 200 shrink and close integrally to clamp the bolt at the moment, so that a clamping force is greater, and a self-locking capability of the nut assembly is greatly improved.

With reference to FIG. 2 to FIG. 5, in order to simplify a structure of the nut assembly, in some embodiments of the disclosure, the anti-dropping structure includes an annular clamping groove 410 and a clamping block 420 which are matched and clamped with each other. The clamping block 420 is arranged on the collar portion 210, the collar portion 210 is movably inserted into the accommodating cavity 110, and the clamping block 420 is movably clamped in the annular clamping groove 410. In the embodiment, along the axial direction of the first nut 100 or the second nut 200, a depth of the annular clamping groove 410 is greater than a thickness of the clamping block 420. By using the above structure, the clamping block 420 is capable of moving in the annular clamping groove 410, which affects relative movement between the first nut 100 and the second nut 200.

It should be noted that, the annular clamping groove 410 may be arranged on an outside wall of the collar portion 210, and the clamping block 420 may also be arranged on an inside wall of the accommodating cavity 110, which may be determined according to actual needs.

In order to facilitate assembly of the first nut 100 and the second nut 200, in some embodiments of the disclosure, the annular clamping groove 410 is arranged on the inside wall of the accommodating cavity 110; and the clamping block 420 is arranged at one end of the collar portion 210 away from the second nut 200. When assembling, it is only necessary to insert the collar portion 210 into the accommodating cavity 110 correspondingly, and embed the clamping block 420 into the annular clamping groove 410, thus being simple and convenient in assembly. In some embodiments of the disclosure, the clamping block 420 is an annular convex strip arranged on a peripheral side wall of the end portion of the collar portion 210. By matching and clamping the annular convex strip with the annular clamping groove 410, the first nut 100 is connected with the second nut 200 more reliably, thus effectively preventing the collar portion 210 from completely dropping out of the accommodating cavity 110, and preventing the first nut from being separated from the second nut. It can be understood that, the clamping block 420 is a convex block arranged on the peripheral side wall of the end portion of the collar portion 210. According to needs, one, two, three or more convex blocks may be provided. In some embodiments of the disclosure, the peripheral side wall of the end portion of the collar portion 210 is provided with a plurality of convex blocks, and the plurality of convex blocks are uniformly arranged at intervals around the peripheral wall of the collar portion 210. By matching and clamping the plurality of convex blocks with the annular clamping groove 410, the collar portion 210 is effectively prevented from completely dropping out of the accommodating cavity 110.

The embodiments of the disclosure are described in detail with reference to the drawings above, but the disclosure is not limited to the above embodiments, and various changes may also be made within the knowledge scope of those of ordinary skills in the art without departing from the purpose of the disclosure.

1. A nut assembly, comprising:
a first nut, wherein one end of the first nut is provided with an open accommodating cavity;
a second nut, wherein the second nut and the first nut are capable of moving close to or away from each other, one end of the second nut is provided with a collar portion, the collar portion is movably inserted into the accommodating cavity, and at least one notch is formed on a side wall of the collar portion;
a squeezing structure arranged between the collar portion and the accommodating cavity, wherein when the first nut and the second nut move close to each other, the squeezing structure is capable of squeezing the collar portion to shrink and close; and
an anti-dropping structure arranged between the first nut and the second nut, wherein the anti-dropping structure is capable of restricting the collar portion from dropping out of the accommodating cavity.

2. The nut assembly of claim 1, wherein,
the collar portion is a conical boss,
the squeezing structure comprises a first guide inclined plane formed on a peripheral side wall of the conical boss, and
when the first nut and the second nut move close to each other, an end portion of the accommodating cavity or an inner wall of the accommodating cavity is contacted with the first guide inclined plane and squeezes the collar portion to shrink and close.

3. The nut assembly of claim 2, wherein,
the squeezing structure comprises a second guide inclined plane formed on an inner wall of the accommodating cavity, and
when the first nut and the second nut move close to each other, the second guide inclined plane is contacted with the first guide inclined plane and squeezes the collar portion to shrink and close.

4. The nut assembly of claim 1, wherein,
the at least one notch comprises a plurality of notches, and the plurality of the notches are arranged at intervals in a circumferential direction of the collar portion.

5. The nut assembly of claim 4, wherein,
the plurality of notches are uniformly arranged in the circumferential direction of the collar portion.

6. The nut assembly of claim 1, wherein,
one of the at least one notch is an open groove penetrating through the collar portion and the second nut.

7. The nut assembly of claim 1, wherein,
the anti-dropping structure comprises an annular clamping groove and a clamping block which are matched and clamped with each other,
one of the annular clamping groove and the clamping block is arranged on an inside wall of the accommodating cavity, and the other one is arranged on the collar portion, and
along an axial direction of the first nut or the second nut, a depth of the annular clamping groove is greater than a thickness of the clamping block.

8. The nut assembly of claim 7, wherein,
the annular clamping groove is arranged on the inside wall of the accommodating cavity; and
the clamping block is arranged at one end of the collar portion away from the second nut.

9. The nut assembly of claim 8, wherein,
the clamping block is a convex block arranged on a peripheral side wall of an end portion of the collar portion.

10. The nut assembly of claim 8, wherein,
the clamping block is an annular convex strip arranged on the peripheral side wall of the end portion of the collar portion.
